(19) United States
(12) Patent Application Publication
(10) Pub. No.: US 2005/0282937 A1
(43) Pub. Date: Dec. 22, 2005

(54) Electrochemical compatibilizer and hydrophobic wetting agent for fiber reinforced vinyl esters and related thermosets

(76) Inventor: Richard C. Petersen, Birmingham, AL (US)

Correspondence Address: Richard C. Petersen;371 Hoehn Biomedical Engineering,, University of Alabama, Birmingham, 1075 South 13th Street, Birmingham, AL, 35294, US

(21) Appl. No.: 10/869,161

(22) Filed: Jun. 16, 2004

(51) Int. Cl. C08L 63/10; C08L 63/00; B32B 27/38

(52) U.S. Cl. 523/443; 523/440; 428/901; 428/413

(57) ABSTRACT

Triclosan, a diphenyl ether additive characterized by molecular electrochemical functionality, is proposed as a unique compatibilizer with nonpolar bisphenyl vinyl ester thermosets and especially those resins containing hydroxyl groups. Electrochemical functionality is being described as alternating conformational changes related to molecular asymmetry where a dipole is either hidden alongside the ether dihedral angle with phenyl planes at about 30 degrees, or the dipole becomes exposed as the phenyl planes rotate toward 90 degrees. Accentuated electrochemical compatibilization through nonbonded Lennard-Jones parameters with molecular similarities related to closer intermolecular distances involves resin polymer chain and monomer entanglement for increased toughness and other improved mechanical properties. Triclosan compatibilization with bisphenyl-A vinyl esters is extreme, allowing major concentrations to be incorporated. The dipole of Triclosan is particularly important where it can open up in the presence of more polar elements or functional groups such that extra curing agents may be required for sufficient free radicals to ensure complete polymerization. Nonpolar electrochemical Triclosan compatibilization is further related to hydrophobic wetting viscosity reduction with disruption of secondary bonding. Lowered resin viscosity then promotes entropic mixing stabilization to improve homogeneous dispersion during fiber resin impregnation with vinyl esters and related monomers, for inclusion of filler particulate, or other polymer modifiers. Hydrophobic wetting becomes especially important when incorporating high levels of filler into molding compound where resin mobility is significantly restricted by reinforcing fibers necessary for mechanical strengths. Additionally, hydrophobic wetting reduces interfacial porosity to improve composite mechanical and physical properties.

### BACKGROUND OF THE INVENTION

### REFERENCES CITED [REFERENCED BY]

### U.S. Patent Documents

| | | | Field of |
|---|---|---|---|
| Patent No. | Date | Author | Search |
| 6,521,732 | Feb. 18, 2003 | Perez, et al | 526/273 |
| 6,518,362 | Feb. 11, 2003 | Clough, et al | 525/362 |
| 5,308,565 | May 3, 1994 | Weber, et al | 264/112 |
| 6,548,174 | Apr. 15, 2003 | Nakajima, et al | 428/413 |
| 6,270,348 | Aug. 7, 2001 | Petersen | 433/228.1 |
| 6,281,265 | Aug. 28, 2001 | Montgomery, et al | 523/122 |
| 6,106,505 | Aug. 22, 2000 | Modak, et al | 604/265 |
| 5,733,949 | Mar. 31, 1998 | Imazato, et al | 523/109 |
| 5,192,531 | Mar. 9, 1993 | Gaffar | 424/52 |
| 5,156,835 | Oct. 20, 1992 | Nabi | 426/52 |
| 4,235,228 | Nov. 25, 1980 | Gaylord, Jr., et al | 602/8 |

### OTHER REFERENCES

Sudhin D and Lobse D J (1996) Polymeric Compatibilizers. New York. Hanser Publishers. pages 1-59
Hinchliffe A. Modelling Molecular Structures. New York. Wiley. Nonbonding Lennard-Jones 12-6 Potentials for Benzene Pages 38-44
Cope, Donald E., and Linnert E., The lowdown on loading down resins using hydrophobic encapsulation, Plastics Engineering, June 1980 pages 37-39
Cope, Donald E, Hydrophobic filler wetting yields better composites, Modern Plastics, July 1980 Pages 60-66
Additives and Modifiers for Compounding, Plastics Compounding 1980 pages 62-63
Additives and Modifiers, Plastics Compounding, V 14, n 4 July-August 1991 page 40
Ciba Product Literature for Irgasan, General information on chemical, physical and microbiological properties
Norden B. and Edlund U. Intramolecular chelation of chlorinated 2-phenoxyphenols. Acta Chemica Scandinavica. B41 (1987) pages 194-197
Imazato, S., Mitsuo, T, and Tsuchitani, Y., Antibacterial effect of composite incorporating Triclosan against Streptococcus mutans, Journal Osaka University Dental School, Volume 35 1995
Lu, J., et al, Formation of Antibiotic, Biodegradable Polymers by Processing with Irgasan DP300R (Triclosan) and Its Inclusion Compound with B-Cyclodextrin, Journal Applied Polymer Science, Volume 82, pages 300-309 2001
Kalyon, B. D., and Olgun, U., Antibacterial efficacy of triclosan-incorporated polymers, American Journal of Infection Control Volume 29 (2) April 2001 pages 124-125
Barbolt T A. Chemistry and safety of Triclosan, and its use as an antimicrobial coating on Coated Vicryl Plus antibacterial Suture (coated polyglactin 910 suture with Triclosan). Sugical Infections. 2002 3 Suppl 1:pages S45:53
Gaffar, A., N. Nabi, B. Kashuba, M. Williams, S. Herles, S. Olsen and J. Afflitto, Antiplaque effects of dentifrices containing triclosan/copolymer/NaF system versus triclosan dentrifices without the coplymer, American Journal of Dentistry, Volume 3: S7-S 14 1990
Zambon, J. J., et al, Effect of a triclosan/copolymer/fluoride dentifrice on the oral microflora, American Journal of Dentistry, Volume 3 1990, pages S27-S34
Garcia-Godoy, Franklin, et al, Effect of a triclosan/copolymer fluoride dentifrice on plaque formation and gingivitis: A 7-month clinical study, Am. J. of Dentistry, Vol. 3 1990 pages S115-S26.
Bhargava, H. N. and Leonard, P. A., Triclosan: Applications and safety, American Journal of Infection Control, Volume 24 (3) June 1996, pages 209-218
Salvatore, J. D., Kong, B. M., and Lin, Y-J., Triclosan: A safety profile, American Journal of Dentistry, Volume 2, Special Issue, September 1989, pages 185-196
Villalain, J., et al, Membranotropic effects of the antibacterial agent Triclosan, Archives of Biochemistry and Biophysics, Volume 390 (1), June 2001 pages 128-136
Tierno, P. M., Efficacy of Triclosan, American Journal of Infection Control, Volume 27 (1) February 1999, pages 71-72
Jones, R. D., et al, Triclosan: A review of effectiveness and safety in health care settings, American Journal of Infection Control, Volume 28 (2) April 2000 Pages 184-196
Swofford, H. W., Antibacterial efficacy of polymers containing triclosan and other antimicrobial additives, American Journal of Infection Control, Volume 29 (6) December 2001, pages 428-429
Petersen, R C and Wenski E G (2002). Mechanical testing of a photocured chopped fiber reinforced dental composite. Soc Advmnt Mater Process Engin 2002-Affordable materials technology-platform to global value and performance: Long Beach: SAMPE: pages 380-
Hansel, C., et al Effects of Various Resin Composite (Co)monomers and Extracts on Two Caries-associated Micro-Organisms in vitro, Journal of Dental Research, Volume 77 (1) January 1998 pages 60-67
Perera, A. H. and Satterfield, M. J., Micromasking of plasma etching due to bacteria: A yield detractor for ULSI, IEEE Transactions on Semiconductor Manufacturing, Volume 9 (4), November 1996, pages 577-580
Harned, W., Bacteria as a particle source in wafer processing equipment, Journal of Environmental Science, May/June 1986, pages 32-34
Savola, W. G., and Wallace, J. T., Deionized water for integrated circuit fabrication, Solid State Technology, November 1973, pages 47-49
Siegmann, R. P., Point-of-use contamination control of ultrapure deionized water for semiconductor processing, Microcontamination March 1987, pages 22-26
Craven, R. A., Ackermann, A. J., and Tremont, P. L., High-purity water technology for silicon-wafer cleaning in VLSI production, Microcontamination November 1986 pages 14-21
Kjaerheim, S. A., and Rolla, B. P., Does the nature of the solvent affect the anti-inflammatory capacity of triclosan?, Journal of Clinical Periodontology, Volume 24 1997, Pages 124-128
Gaffar, et al, The effect of triclosan on mediators of gingival inflammation, Journal of Clinical Periodontology, Volume 22 1995 pages 480-484
Barkvoll, P., and Rolla, G., Triclosan reduces the clinical symptoms of the allergic patch test reaction (APR) elicited with 1% nickel sulfate in sensitized patients, Journal of Clinical Periodontology, Volume 22 1995 pages 485-487
Barkvoll, P., and Rolla, G. Triclosan protects the skin against dermatitis caused by sodium lauryl sulfate exposure, Journal of Clinical Periodontology, Volume 21 1994 pages 717-719
Modeer, T. et al, Triclosan reduces prostaglandin biosynthesis in human gingival fibroblasts challenged with interleukin-1 in vitro, Journal of Clinical Periodontology, Volume 23 1996 pages 927-933
Mustafa, M et al, Effect of triclosan on interferon-gamma production and major histocompatibility complex class II expression in human gingival fibroblasts, Journal of Clinical Periodontology, 2000: Volume 27, pages 733-737
Kjarheim, V., et al, Effects of triclosan on the rat phrenic nerve-diaphragm preparation, Journal of Clinical Periodontology, Volume 22, 1995 pages 488-493

1. Field of the Invention

The present invention describes Triclosan, an organic molecular-electrochemical diphenyl ether molecule that compatibilizes by closely matching intermolecular Lennard-Jones 12-6 potentials with nonpolar bisphenyl epoxy derived vinyl ester thermoset resins in addition to related resins and diluent monomers showing similar miscibility. Dipole electrochemical changes resulting from rotation about the Triclosan ether oxygen atom suggests a means for “perturbation” near interfaces that are polar/nonpolar. Triclosan is a hydrophobic wetting agent as a nonpolar electrochemical additive that reduces resin viscosity, which is especially important during mixing and when impregnating fibers or other filler additives. Resin cure can be effected with various free radical initiators and accelerators activated by either photo-energy, chemical mixing, or thermally. However, when the dipole of Triclosan becomes exposed in more polar environments, additional curing agents may be required to ensure sufficient free radicals for complete polymerization. Nonpolar chemical similarities between Triclosan and vinyl ester resins are so complete that compatibilization strengths occur at major concentration levels while curable filler mass compositions of the crystalline Triclosan powder can exceed 90 wt %.

Reaction of an epoxy resin, and most specifically diglycidyl ether bisphenol-A, with methacrylic acid produces the most common vinyl ester resin. Vinyl esters are regarded as a major class of resins for fiber reinforced materials. Vinyl esters are considered a superior resin system to unsaturated polyesters for advanced fiber reinforced compounds, demonstrating excellent moisture resistance and hydrolytic stability due to ester linkages being terminal with shielding by methyl groups. Both polyesters and vinyl esters adsorb less moisture than epoxies as a consequence of lower polar functional groups. However, vinyl ester resins are still exceedingly crosslinked, resulting in brittleness and low fracture toughness properties. Also, vinyl esters require high levels of diluent monomer to reduce viscosity for acceptable process levels. Monomers can then adversely affect material properties especially as a result of cure shrinkage, creating internal residual stresses that can in turn lead to microcracking, crack propagation, chipping and even early adverse failure.

Brittleness of the matrix resin limits fiber reinforced durability especially in structural applications subject to cyclic fatigue. Consequently, extensive research has been launched over the last decade to improve resin toughness. Quite often, use of rubber modifiers can accomplish this toughening, but at a sacrifice of creating higher viscosities. Conversely, Triclosan with molecular-electrochemical “perturbation” functionality will be shown to be an effective toughener for vinyl esters by increasing strengths through polymer entanglement from polymer compatibilization, while also reducing viscosity. Toughness is thought to improve during compatibilization as refined blending prevents agglomeration that separates domains. Polymer entanglement further enhances strain as a means to release energy during impact compared to crack propagation in brittle crosslinked resins. Current tougheners suffer from moisture adsorption that should not be a problem with a nonpolar molecule such as Triclosan. Lower moisture adsorption is then associated with higher Tg, lower dielectric constant, better mechanical properties, less outgassing, dimensional stability and lower weight change. A toughened fiber reinforced material will adsorb more energy to restrict interlaminar shearing, adsorb greater energy during impact or fatigue and subsequently allow fabrication of thinner more durable parts with greater design capability for potential weight savings. Toughness properties then resist chipping, which is especially important for tissue-related biomaterials where thinner areas may become rate-limiting factors for clinical success. Modified toughened vinyl ester resins may be ideal for coatings, cements, toughened matrix resins for fiber-reinforced compounds, and structural adhesive applications. Lower viscosity for less volatile monomer is another benefit for workers in the field.

Most previous long term proof of Triclosan antimicrobial efficacy has been primarily related to free solubility in oral healthcare products. Although the Food and Drug Administration (FDA) acknowledged benefits to include antigingivitis, anticaries claims could not be made. Triclosan was also recently FDA approved for use as a coating in resorbable Vicryl sutures. Since practical surface antimicrobial protection cannot be currently presented without long term studies when permanently composited into a crosslinked thermoset, use of Triclosan must nevertheless acknowledge the difficulties associated during microbial contact. Examples of such thermoset resin systems that could possibly benefit from antimicrobial protection include dental fiber-reinforced molding compound service along margins susceptible to recurrent decay, orthopedic cements and related implant devices vulnerable to more serious clinical infections, or polymers associated with performance related micro circuitry considered targets for microbes.

2. Description of the Prior Art

Mechanical testing has not yet been demonstrated with Triclosan polymers for either thermoplastics or thermosets at any level in journal literature. Concentrations in polymer materials are low and only reported up to 5 wt % as a maximum in thermoplastics. Infinitesimal levels at 0.02 ppm of Triclosan release in water over a 24-hour period from a thermoset dental compound containing 1.0 wt % additive indicates extremely prolonged retention probably for the life of the filling. Release is so minimal practically that antimicrobial protection may be limited at low composite concentrations. On the other hand, slow release of Triclosan into protected microdefects over extended periods emphasizes such long-term antimicrobial activity particularly relevant while examining higher concentrations that do not interfere with mechanical strengths when crosslinked into a bisphenyl-A vinyl ester thermoset resin. Triclosan has also previously been described for use in orthopedic plaster cast and experimental thermoplastic medical catheters.

Fiber reinforcement and advanced fiber reinforced adhesives are a major impetus toward thermoset development using Triclosan. With fiber reinforcement an added certainty is provided to improve mechanical strengths and reduce marginal chipping while physical properties will not be compromised at any level but will rather improve by taking advantage of hydrophobic wetting and compatibilizer attributes. The United States Department of Energy (DOE) Federal Manufacturing and Technologies Kansas City Plant has evaluated photocure fiber reinforced compound with commercial particulate filled composites. In the DOE assessment, reinforcing fibers were hailed as a major breakthrough for photocure materials by vastly improving strength, modulus, low strain rate toughness and high strain rate toughness.

Once fibers attain a critical length for a specific resin system, most other properties are similarly improved with increasing aspect ratio. As fibers lengthen relative to their diameters, strengths (tensile, flexural, fatigue), modulus, toughness and impact resistance all increase. Reduced overall polymerization shrinkage occurs with increasing aspect-ratio particularly along the fiber axis with less shrinkage stresses and lower creep. Wear improves in conjunction with underlying mechanical strength properties that supports loading, particularly as the reinforcement length extends beyond the average plowing groove. Fibers are also used as a carrier mechanism for structural adhesives to control bondline thickness/pressure and raise toughness. Surface Roughness is not compromised by addition of fibers where resin squeezes out to determine the final finish against the mold surface and rotary grinding will subsequently be related primarily to the final polishing sequence. Using high purity quartz fibers protected under Title III of the 1986 Defense Production Act as a strategic material further provides the foremost levels of quality assurance.

Triclosan, FIG. 1a, acts as a wetting agent through intermolecular matching by Lennard-Jones parameters or more commonly referred to as compatibilization with the most common vinyl ester resin, FIG. 1b. Triclosan and bisphenyl-A vinyl ester compatibilization will lower resin viscosity through disruption of secondary bonding and offer improved compatibilization with diluent monomers, FIGS. 1c and 1d. With regard to phenyl Lennard-Jones 12-6 parameters, both Triclosan and the vinyl ester are diphenyl and ethers stabilized at the para positions while hydroxyl groups are associated at a nonpolar location. Alkyl, phenol and phenyl ethers are all activating electron donating ortho, para directors for benzene whereas the halogens are deactivating electron withdrawing ortho, para directing. Para chloro groups asymmetrically electron withdraw and destabilize the ortho hydroxyl and chloro groups. Further, Triclosan is stabilized by intramolecular hydrogen bonding between the hydroxyl group and ether oxygen in addition to the ortho secondary bonding between the chlorine atom and ether oxygen. In its most stable conformation pure state, the Triclosan dipole is isolated alongside the ether oxygen tetrahedral. As Triclosan is exposed to more polar elements, the ether oxygen atom bonds can rotate to open up the dipole moment. Molecular electrochemical agitation along the vinyl ester monomer chain improves intermolecular matching of monomers as Triclosan should emphasize disruption of secondary hydrogen bonding at the 2 hydroxy positions. Interference with vinyl ester hydrogen bonding will subsequently reduce viscosity. Vinyl esters by definition contain ester C—O bond linkages that further appear to aid in compatibilizing by Lennard-Jones 12-6 parameters with Triclosan as a diphenyl C—O—C ether.

Lower vinyl ester resin viscosity upon addition of Triclosan thus requires less monomer that is associated with increased bacterial colonization. Lower resin viscosity can also improve filler loading with better dispersion/antisettling to extend modifier uses for chemical resistance, pigments, fumed silica thixotropes, adhesives, thickeners, tougheners, low profile shrinkage control additives, radio-opacifiers, thermal conductivity/insulation, electrical conductivity/insulation, flame retardant and other additives required for various specialty utilization. Increased filler and reinforcement will result in higher modulus with less cure shrinkage residual internal stresses and thus less microcracking with reduced chipping in addition to less water sorption, and improved wear. Fiber reinforcement will wet or roll out better to improve strength and all other properties. Fiber reinforcement can then replace packing consistency following viscosity breakdown by Triclosan for a fully condensable molding compound especially when incorporating thickening additives to help control resin flow.

Hydrophobic wetting agents in addition to viscosity reductions are noted for better surface smoothness, and increased mechanical properties. Hydrophobic wetting agents are uniformly described as able to work in synergy with silanes demonstrating best performance for quartz and silica. Hydrophobic wetting agents are thought to displace air at the filler/reinforcement interface, as resin flow is improved without increasing polar surface energy. Hydrophobicity lowers polarity to reduce water adsorption and so should protect susceptible ester linkages in vinyl ester resins. Any reduction in porosity will further reduce water adsorption. Decreased water adsorption should then lessen the possibility of internal stresses and fiber debonding from the resin matrix that can result in loss of mechanical properties. Intermolecular matching with bisphenyl vinyl esters decreases the ability of Triclosan to leach out even more for exceedingly long-term retention, so that substantivity is projected for the lifetime of the material, especially at elevated concentrations. Lower vinyl ester resin viscosity will even require less monomer related to polymerization cure shrinkage and internal stress microcracking.

Triclosan will be shown to act as a compatibilizer with vinyl ester resins through molecular chemical similarities by Lennard-Jones parameters. Compatibilization is accentuated by dipole molecular-electrochemical functionality through rotation about the oxygen ether atom for demonstrated increases in strength, considered an indication that polymer entanglement associated with toughness has occurred. Separation of polymer domains is reduced through compatibilization for improved blending with the monomer crosslinking agents. Compatibilization of Triclosan with bisphenyl-A vinyl esters is so complete that concentrations can extend up to 90 wt % for a photocurable material. Of course, extra curing agent is incorporated to counteract free radical interference by the dipole of Triclosan that becomes exposed by bond rotation around the ether oxygen atom.

The mechanical property of toughness has been a chief goal for years with the brittle highly crosslinked vinyl ester resins in order to improve durability with fiber reinforced composites. By substituting Triclosan for other toughening agents, viscosity will not be a problem and additional monomer with residual cure stresses will not be increased. Also Triclosan as a hydrophobic compatibilizer will again not increase water adsorption, responsible for numerous reductions in material mechanical strengths and physical properties. As a hydrophobic toughener through compatibilization, Triclosan should then also improve vinyl ester coatings, structural adhesives, cements, sealants, photoresists, circuit boards, and electrical encapsulants.

Fluoride containing materials have shown reduced caries associated with dental fillings when compared to composites or amalgams during short term testing. However, glass ionomers have low brittle mechanical strengths and cannot be recommended in posterior areas under occlusal stress. Dual chemical/photocure fiber reinforcement will not only improve glass ionomer mechanical properties, but it will be suggested from mechanical testing that acrylic acid-base condensation reactions with quartz fiber silica hydroxyl groups improves stress transfer bonding with resin to actually increase mechanical strengths above fiber reinforced composites. Enamel surrounding fluoride-containing fillings becomes more acid resistant and less prone to decay while bacterial plaque is inhibited. Although glass ionomer fluoride release declines rapidly in time, Triclosan can provide long-term retention. Chlorhexidine has also been investigated toward antibacterial properties for dental restorative materials, but has demonstrated poor bonding characteristics and will stain teeth in addition to interfering with essential toothpaste anionics. Conversely, specifically at the tooth interface, nonpolar Triclosan is not a cationic that can precipitate anionics in foods to stain teeth, complex fluoride to interfere with bactericidal activity, prevent enamel fluoride uptake or neutralize toothpaste anionics necessary for cleaning.

Triclosan is a white crystalline powder and a nonpolar molecule, thus conferring low water solubility of 10 ug/ml at 20 C° and 40 ug/ml at 50 C° that translates into long-term retention for a composite material. Volumes of studies were undertaken over the last thirty years demonstrating the safety and efficacy of Triclosan. Triclosan is not toxic, nor a skin irritant, not mutagenic and not carcinogenic. Laboratory rats have been reported to ingest greater than 5000 mg/Kg without ill effect. Triclosan activity has further shown to be effective in parts per million for a large number of bacterial having minimum inhibitory concentrations well below Triclosan solubility, Table 1. Bactericidal action may subsequently be realized within inaccessible moisture microenvironments such as microvoids or microgaps where solubility equilibrium can be attained, especially at high concentrations that compatibilize with vinyl ester resins.

TABLE 1
MINIMUM INHIBITORY TRICLOSAN CONCENTRATIONS
Triclosan water solubility approximately 30 ug/ml at 37 C. °

| | | |
|---|---|---|
| Laboratory Bacterial Strains | (ug/ml) | strain |

Oral Bacteria

| | | |
|---|---|---|
| Actinomyces viscosus | 0.8 | NCTC10951 |
| Actinomyces viscosus | 5.0 | T14V |
| Actinomyces israeli | 1.0 | NCTC8047 |
| Actinomyces naeslundi | 1.0 | A |
| Actinomyces naeslundi | 1.0 | 12104 |
| Actinomyces odontolyticus | 0.8 | NCTC9935 |
| Streptococcus mitor | 0.8 | NCTC7864 |
| Streptococcus mitor | 1.1 | NCTC10712 |
| Streptococcus mutans | 5.0 | 6715 |
| Steptococcus sobrinus | 11.0 | OMZ176 |
| Steptococcus sanguis | 2.0 | 34 |
| Porphyromonas gingivalis | 2.0 | OMZ309 |
| Actinobacillus | 5.0 | Y4 |
| actinomycesemcomitans | | |
| Bacteroides gingivalis | 2.5 | 381 |
| Bacteroides intermedius | 2.5 | 581 |
| Bacteroides intermedius | 0.4 | NCTC9336 |
| Fusobacterium nucleatum | 1.2 | NCTC10562 |
| Veillonella parvula | 5.4 | NCTC |
| C. ochracea | <0.4 | NCTC11654 |
| Peptococcus asacchrolyticus | <0.6 | NCTC |
| Lactobacilli | 33.0 | |

Fresh Isolate Strains from Human Plaque, Colgate-Palmolive Data

| | | |
|---|---|---|
| Actinomyces actinomycetemcomitans | <0.3 | 1426 |
| Actinomyces actinomycetemcomitans | <0.3 | 1483 |
| Actinomyces odontolyticus | 0.8 | 1041 |
| Actinomyces odontolyticus | 0.8 | 1431 |
| Actinomyces viscosus | 0.8 | 1218 |
| Capnocytophaga spp | 0.8 | 287 |
| Capnocytophaga spp | 2.3 | 290 |
| Capnocytophaga spp | 0.8 | 310 |
| Fusobacterium nucleatum | 0.8 | 1446 |
| Fusobacterium nucleatum | NA | 1482 |
| P. anaerobius | 0.6 | 580 |
| P. anaerobius | 2.3 | 1198 |
| Peptostreptococcus micros | NA | 1414 |
| Peptostreptococcus micros | 3.1 | 1422 |
| Porphyromonas gingivalis | NA | |
| P. acnes | 2.3 | 1305 |
| S. milleri | 2.3 | 1339 |
| S. milleri | 2.3 | 1391 |
| S. mitior | 2.3 | 1384 |
| S. mitior | 2.3 | 1387 |
| Veillonella. parvula | 6.2 | 1167 |
| Veillonella. parvula | 2.3 | 1459 |
| W. recta | 0.8 | |

Bacteria Associated with Polymeric Medical Devices

| | | |
|---|---|---|
| Staphlococcus aureus | <0.125 | ATCC29213 |
| Staphlococcus aureus | 0.05 | ATCC9144 |
| Staphlococcus aureus | 0.01 | NCTC12232 |
| Staphlococcus aureus | 0.02 | NCTC11150 |
| Staphlococcus epidermidis | <0.125 | ATCC12228 |
| Staphlococcus hyicus | 0.03 | ATCC27844 |
| Staphlococcus hominus | 1.0 | ATCC27844 |
| Staphlococcus saprohyticus | 0.1 | NCTC7292 |
| Escherichia coli | 0.3 | ATCC9661 |
| Escherichia coli | 0.02 | NCTC8196 |
| Escherichia coli | 0.5 | NCTC11186 |
| Escherichia coli | 0.1 | ATCC43888 |
| Corynebacterium | 3.0 | ATCC6919 |
| (Propionibacterium) acnes | | |
| Pseudomonas aeruginosa | >1000 | ATCC12055 |
| Pseudomonas aeruginosa | >1000 | NCTC8060 |
| Listeria monocytogenes | 1.0 | ATCC15313 |
| Salmonella enteritidis | 0.1 | A |

Yeast

| | | |
|---|---|---|
| Candida albicans | 3.0 | ATCC10259 |
| Candida albicans | 10.0 | A |

Although examined at great lengths for oral healthcare products such as toothpaste and mouthwash, no testing has been reported in the journals on effects of Triclosan toward polymer mechanical strength. One investigation examining Triclosan in a dental composite established reduced Streptococcus mutans formation and adhesion over a twenty four-hour period with just 1.0 wt % concentration. Thermoplastic polymers have been tested for Triclosan, with concentrations extending up to 5-wt %. Experimental medical catheters have been examined in rabbits using ethylvinyl acetate and polypropylene up to 2.0 wt % demonstrating effectiveness against Staphylococcus aureus, Staphylococcus epidermidis, Escherichia coli and Candida albicans, but also showing high leaching, indicating lowered compatibilization in polymers lacking bisphenyl structures.

Commercialization of Triclosan in toothpaste and mouthwash actually required a breakthrough in polymer research to slow antimicrobial release for substantivity. Fortunately, retention of Triclosan will not be a problem when crosslinked into a hardened polymerized dental composite with a highly miscible intermolecularly related vinyl ester resin. It is speculated that Triclosan may provide polymer surface antimicrobial properties through direct uptake by bacteria in close contact. It is anticipated that the nonpolar nature of Triclosan will compete with the hydrophobic state of the polymer and will diffuse onto a lipophillic cell wall to possibly disrupt the integrity toward killing above minimum inhibitory concentrations. The most obvious inhibitory disruptive mechanism of the bacterial cell wall would be during cell division. Bacteria require an intact cell wall during cell division since prokaryotes lack a cytoskeleton and mitotic spindle. Persistence is described for lipid-soluble Triclosan, which apparently builds up along nonpolar sites such as mucosal cells that may further include nonpolar hydrophobic polymer-based composite.

Triclosan, FIG. 1a, is an asymmetric molecule that will undergo molecular-electro-chemical conformational alterations alternately exposing a dipole, which appears to create a defect and cause cell wall disruption most importantly during cell division. Perturbations are particularly described along the fatty acid tail in the ester region near the phospholipids head. Therefore, presumably due to generalized cell wall disruption during cell division, site specificity is not an effect that is associated with antibiotic resistance. Triclosan conversely is an extremely generalized nonpolar compound having multiple sites of action so that resistance has not been reported de novo in over thirty years. Also molecular stability precludes bacterial breakdown of Triclosan. Experts are beginning to agree that Triclosan resistance will not occur in a natural environment, but only tolerance under excessive situations with less pathogenic strains. In fact, freely released Triclosan as 0.3% concentration has been approved for FDA over the counter daily use in oral healthcare products such as toothpaste and mouthwash, indicating high confidence in a low potential for producing resistant oral bacterial strains. However, FDA claims can only include antigingivitis since anticaries activity could not be provided during long-term studies. Triclosan was also FDA approved for coating resorbable Vicryl sutures.

Triclosan is projected for use in Medical cements due to the safety profile associated with compatibilization through the acrylic ester linkage whereby strengths are augmented. Triclosan compatibilization with acrylic further includes hydrophobic wetting, which improves mixing, considered an extremely important asset in a clinical surgical setting. Hydrophobic wetting will therefore aid in adding radio-opaque or antibiotic filler and even reinforcing fibers.

The complications of infection with Orthopedic hip implants are serious issues, occurring now at the Mayo Clinic with a rate of 1.3% during primary surgery and up to 3.2% at revision, which describes large numbers of neutrophiles. When the criteria becomes stricter, infection has been estimated to be associated with failure before initial revision at 30-40%, indicating 5 polymorphonuclear leukocytes per high power field. Infection retards wound healing and there is a general indication that biomaterial acting as an adjuvant with inflammatory antigens from a subclinical undetectable infection may produce an overall condition resulting in implant failure. Bacterial proteoglycan by-products further act as a barrier combined with the implant itself to prevent antibiotics from approaching so that microbial persistence is a problem. Therefore, broadspectrum antimicrobial action by Triclosan is expected to provide a level of bioperformance control toward increasing material lifetimes.

Selective antibiotics compatible with free radical chemistry can be added to acrylic or copolymer bone cement. Nevertheless, since strengths are compromised due to molecular antibiotic polarity that segregates into stress concentrators, only approximately 2.0-3.0 wt % can be recommended and microbial protection is not broad-spectrum. On the other hand, broad-spectrum antimicrobial Triclosan will be shown with nonpolar chemistries to be entirely compatible with free radical acrylic bone cement curing and capable of high concentration levels without loss of strength. Triclosan would then be immediately available at the cement interface within the deepest region most protected by glycocalyx.

Triclosan is not only a broad-spectrum antimicrobial, but also recognized as an anti-inflammatory and analgesic pain reducer that overall may become an important additive toward improving polymer based implants in terms of material longevity as well as quality of life standards. Sub clinical infection related to pain would be better controlled along with released toxins that exacerbate inflammatory micro trauma by relieving the nociceptor receptor units that signal nerve membrane irritation. Fortunately, minimum inhibitory concentrations for bacteria most associated in hip implant infections, Staphylococcus aureus and Staphylococcus epidermidus, are an order of magnitude lower than well studied oral bacteria concentrations, Table I. It should further be noted that complications increase in orthopedic hip implants with patients compromised by organ transplants. Moreover, a new surgical procedure to stabilize the spine with acrylic cement, vertebroplasty, conceivably could entail consequences that are more serious than the hip implant if infection or mechanical failure presents itself at any insignificant level. In addition, all other polymer medical devices are associated with infections by organisms derived from normal cutaneous, mucosal or intestinal flora that are not ordinarily considered pathogenic with minimum inhibitory concentrations generally well below Triclosan's solubility.

### SUMMARY OF THE INVENTION

The present invention describes use of Triclosan, a well-established broad-spectrum antimicrobial for use in thermoset resins increasing up to relatively high concentrations. In fact, strength increases will be demonstrated at major concentration levels as a result of compatibilization related to resin entanglement associated primarily with toughness. Triclosan, FIG. 1a, demonstrates an intermolecular miscibility potential with hydrophobic nonpolar organic thermosets, highly accentuated with vinyl ester resins having bisphenyl-A structures with nearby hydroxyl groups that can participate in secondary hydrogen bonding to substantially increase viscosity, FIG. 1b. Miscibility is further seen with related thermoset resins and diluent monomers required for viscosity reduction and crosslinking possibly due to the ester linkage/ether C—O bond similarities according to Lennard-Jones parameters and molecular polarities, FIGS. 1c and 1d. Mixing porosity with neat resin is reduced as a benefit to conceivably limit microbial attachment related to surface roughness and low flow cleansing at dead spots. Diminished viscosity permits additional incorporation of particulate filler and fiber reinforcement related to modulus, strength, toughness, wear resistance, and several other important mechanical strengths or physical properties.

Compatibilizers are used to reduce agglomeration of polymer domains for improved mixing, primarily through providing a chemical molecular link between various resin or monomer entities by Lennard-Jones parameters. Compatibilizers are further thought to act by resin entanglement, which usually results in toughness improvements, but can also include strengths. Toughness improvements for fiber reinforced composite resins then become an important goal toward reducing cross-linked matrix brittleness and increasing overall material longevity. Toughness increases by polymer entanglement do not result from interatomic bonding but rather manifest mechanical energy adsorption through increased strain and possibly strength, thus generally reducing modulus. In addition while performing as a molecular electrochemical compatibilizer; Triclosan can safely be used at major concentrations in vinyl ester resin and acrylic polymer systems toward long-term antimicrobial, anti-inflammatory and analgesic protection. Since the dipole of Triclosan can become exposed in more polar environments, additional curing agents are recommended when high concentrations of the additive Triclosan are incorporated so that sufficient free radicals are available.

Hydrophobic wetting is defined as a means to reduce air and moisture along an interface with a material compatible with both the resin and solid mediums. Due to resin viscosity and nonpolarity, wetting of fibers or filler becomes difficult. Hydrophobic wetting agents lower resin viscosity, reduce air incorporated mixing porosity, improve resin mobility and thus provide enhanced wetting while resin impregnating particulate filler or fiber reinforcement. Random filler dispersion by hydrophobic wetting is described as entropic to lower the energy state for more stability with less re-aggregation or separation. Molecular-electrochemically as a unique hydrophobic wetting agent, Triclosan disrupts secondary bonding responsible for unusually elevated viscosities with highly filled composites. As a result of dual filler loading with fiber reinforced molding compounds, hydrophobic wetting agents are necessary and are considered an additive responsible for strength improvements most particularly related to toughness. Hydrophobic encapsulation reduces moisture uptake by chemical thickeners that rely on a secondary bonding maturation process after mixing. Mixing times are also reduced through lower viscosity with better wetting.

In terms of safety, Triclosan has been given FDA approval for over the counter daily use in toothpaste at 0.3% as an active freely released material in a mobile flowing copolymer that will coat and adhere to exposed surfaces. Triclosan is also FDA approved as a coating for resorbable Vicryl sutures. Triclosan is further considered an anti-inflammatory and even analgesic. Triclosan is sparingly soluble at 0.001 grams per liter at 20 C° so that when cured into a compatibilized crosslinked thermoset resin system, activity should be provided for the lifetime of the material.

As a consequence of Triclosan nonpolar chemistry, residual ionomer particulate stress concentrations may be an issue during segregation between polar domains where fracture toughness and modulus deficiencies can result in small defect chipping. Although strain related toughening by polymer entanglement will provide energy adsorption to resist chipping especially when strength is improved, increased strain will also develop lower modulus in the resin that should increase internal polymerization stress microcracking following loading. Latent microcrack damage can then lead toward crack propagation and chipping. Loss of modulus by strain macroscopically is even an expression of reduced interatomic bonding forces that resist separation of atoms in a material. Antimicrobial benefits from an additive such as Triclosan must be considered minimal at best when crosslinked into a polymer if chipping does consequently occur. So accordingly when material permanency is demanded, fiber reinforcement permits the freedom to provide Triclosan antimicrobial protection and improved toughness durability for thermoset resin composites with a large safety factor when increasing most of the important mechanical properties.

Fiber reinforcement has previously been investigated in U.S. Pat. No. 6,270,348 where resin mobility was emphasized toward impregnating reinforcement to actualize large mechanical strengths. Fiber reinforcement was further validation tested by the United States Department of Energy (DOE) Federal Manufacturing and Technologies Kansas City Plant. Proof testing by the DOE demonstrated breakthrough improvements in flexural strength, modulus, work of fracture and Izod impact toughness when compared to photocure commercial particulate filled composites. Correspondingly, Triclosan as a compatibilizer by molecular-electrochemical dipole perturbations to disrupt secondary bonding improves resin impregnation of fibers or filler. Viscosity reduction has previously been shown synergistically to work with silanes as a hydrophobic wetting agent, notable disengaging secondary bonds that interfere with resin mobility. Compatibilization by molecular similarity also resin toughens for reinforced durability by polymer entanglement. Fibers can subsequently reestablish viscosity lost by addition of Triclosan to promote compound molding. Nevertheless, when considering practical antimicrobial, anti-inflammatory or analgesic patient benefits in a hardened material, the Food and Drug Administration must necessarily approve such healthcare claims, which will require extensive long-term proof.

Therefore the following interests are presented.

Triclosan as a molecular-electro-chemical functional molecule is a modifier for compatibilization toward entanglement toughness and strength in thermoset vinyl ester resin-based materials and related polymers, resins or monomers.

In an embodiment, Triclosan as a molecular-electro-chemical compatibilizer is further used to provide hydrophobic wetting for improving resin mobility during filler/reinforcement impregnation in thermoset vinyl ester resin based materials and related polymers, resins or monomers.

In an embodiment, Triclosan as a molecular-electro-chemical additive can be used at major concentrations for compatibilization and hydrophobic wetting in thermoset vinyl ester resin based materials and related polymers, resins or monomers; electrochemical functionality superimposes constraints related to a dipole that becomes exposed as the modifier is surrounded by more polar environments, necessitating higher levels of curing agents to ensure sufficient free radicals for polymerization especially at high levels of Triclosan.

Accordingly in an embodiment of the present invention, a material is disclosed which includes: a thermoset resin; a plurality of silica-based fibers at least 1-3 mm in length mixed into a resin; wherein Triclosan has a concentration greater than 1.0 wt % of the total material mass composition.

In an embodiment, the material includes: a thermoset resin; a plurality of silica-based fibers at least 1-3 mm in length mixed into the resin; wherein Triclosan has a concentration greater than 2.0 wt % of the total material mass composition.

In an embodiment, the material includes: a thermoset resin; a plurality of silica-based fibers at least 1-3 mm in length mixed into the resin; wherein Triclosan has a concentration greater than 5.0 wt % of the total material mass composition.

In an embodiment, the material includes: a thermoset resin; a plurality of silica-based fibers at least 1-3 mm in length mixed into the resin; wherein Triclosan has a concentration greater than 10.0 wt % of the total material mass composition.

In an embodiment, the material includes: a thermoset resin; a plurality of silica-based fibers at least 1-3 mm in length mixed into the resin; wherein Triclosan has a concentration greater than 20.0 wt % of the total material mass composition.

In an embodiment, the material includes: a thermoset resin that is a glass ionomer; wherein Triclosan has been compounded and a plurality of silica-based fibers at least 1-3 mm in length may be in the resin.

Accordingly, in an embodiment of the present invention, a material is disclosed which includes: a neat vinyl ester thermoset cure resin system; wherein Triclosan has a concentration greater than 1.0 wt % of the neat resin.

In an embodiment, the material contains a neat vinyl ester thermoset resin system; wherein Triclosan has a concentration greater than 5.0 wt % of the neat resin.

In an embodiment, the material contains a neat vinyl ester thermoset resin system; wherein Triclosan has a concentration greater than 10.0 wt % of the neat resin.

In an embodiment, the material contains a neat vinyl ester thermoset resin system; wherein Triclosan has a concentration greater than 20.0 wt % of the neat resin.

In an embodiment, the material contains a neat vinyl ester thermoset resin system; wherein Triclosan has a concentration greater than 90.0 wt % of the neat resin.

Accordingly in an embodiment, the material is used in an acrylic-based or thermoset copolymer thereof for orthopedic bone cement and has a Triclosan concentration of at least 1.0 wt % of the total polymer mass.

In an embodiment, the material is used in acrylic-based or copolymers thereof for orthopedic bone cement and has a concentration of Triclosan of at least 5.0 wt % of the total polymer mass.

In an embodiment, the material is used in acrylic-based or copolymers thereof for orthopedic bone cement and has a concentration of Triclosan of at least 10.0 wt % of the total polymer mass.

In an embodiment, the material is added to acrylic-based or copolymers thereof for medical orthopedic bone cement and includes Triclosan; wherein silica-based fibers at least 1-3 mm in length are added to control viscosity loss from excessive hydrophobic wetting by thickening as a consequence of restricting resin mobility while improving mechanical properties.

In an embodiment, the material includes: a thermoset resin wherein Triclosan has been compounded with a nominal amount of silica-based fibers for reinforcing an adhesive or cement or sealant.

In an embodiment, the Triclosan containing material is used to protect microelectronics as a coating or encapsulant and when placed within photoresists.

Additional advantageous features of the present invention will be more apparent when presented in the Description of the Drawings and Detailed Description of the Preferred Embodiments.

### DESCRIPTION OF THE DRAWINGS

FIGS. 1a-1d show the chemical structure of Triclosan, 1a, the most common vinyl ester resin, 1b, crosslinking monomers, 1c, and methylmethacrylate monomer, 1d.

FIGS. 2a-b, show a Chart indicating Hydrophobic Wetting related to a Condensing Scale when Triclosan is added, 2a. In a similar composite model, flexural strengths are compared as Triclosan is added (Post cure in water at 37 degrees for 24 hours), 2b.

FIG. 3 shows a chart for neat vinyl ester resin tested with addition of Triclosan by measuring flexural strength (Post cure in water at 37 degrees for 24 hours).

FIGS. 4a-4c show a model described in the Detailed Descriptions how a minimum fiber length is necessary to attain maximum strengths counteracted by shearing effects when a composite is in tension, 4a, a chart for fiber reinforcement with and without 10 wt % Triclosan (Post cure in water at 37 degrees for 24 hours), 4b, and a chart indicating the importance of fibers to reduce voids caused by resin tack and reduced viscosity, 4c.

FIG. 5 Shows a chart for resin reinforced glass ionomer when nonresin impregnated fibers are added (Post cure at 37 degrees for 24 hours).

FIG. 6 shows a chart for glass ionomer when Triclosan is added (With and without post cure in water at 37 degrees for 24 hours).

FIG. 7 shows a chart when Triclosan and resin preimpregnated fibers are incorporated into resin reinforced glass ionomer (Post cure in water at 37 degrees for 24 hours).

FIG. 8 shows a chart for an overall view of 35 wt % fiber reinforced composite with resin reinforced glass ionomer and Triclosan (Post cure in water at 37 degrees for 24 hours).

FIG. 9 shows a chart demonstrating compatibilization of a chemical polymethlymethacrylate bone cement model with Triclosan and resultant improvements from resin preimpregnated 3 mm quartz fibers (Post cure in water at 37 degrees for 24 hours).

FIG. 10 shows the energy state of Triclosan as the oxygen bonds rotate.

FIG. 11 shows the Triclosan dipole as the oxygen bond has rotated approximately 80 degrees

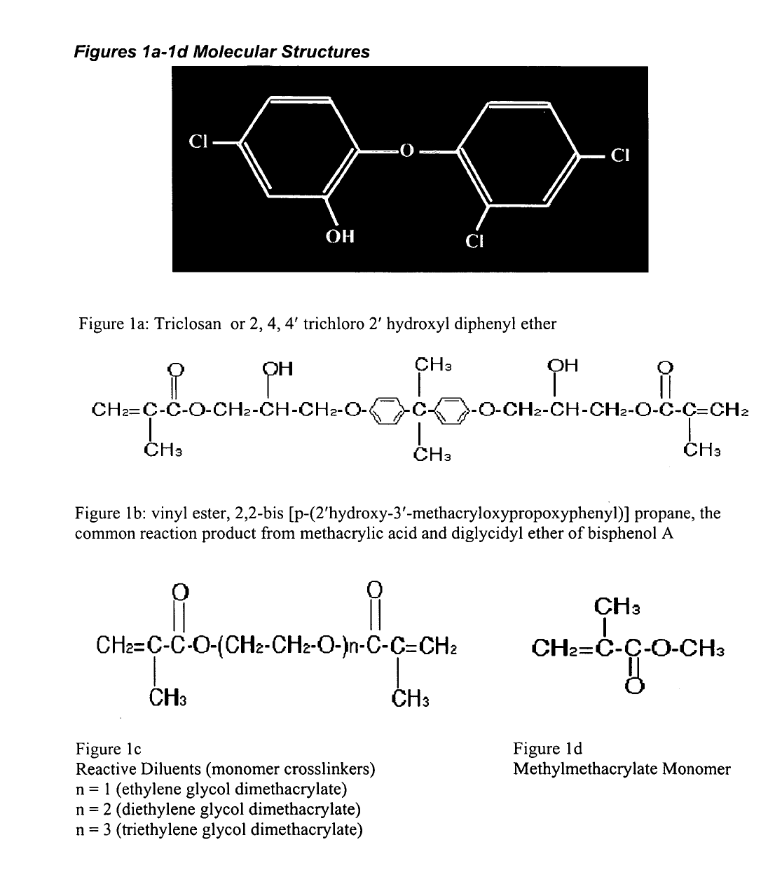

### DETAILED DESCRIPTION OF THE PREFERRED EMBODIMENTS

### Strength Test Standards

Flexural Strength is a common test recommended for small samples to evaluate mechanical properties by the American Standards Testing for Materials, The American Dental Association, the American National Standards Institute and the International Standards Organization.

### Hydrophobic Wetting Agent

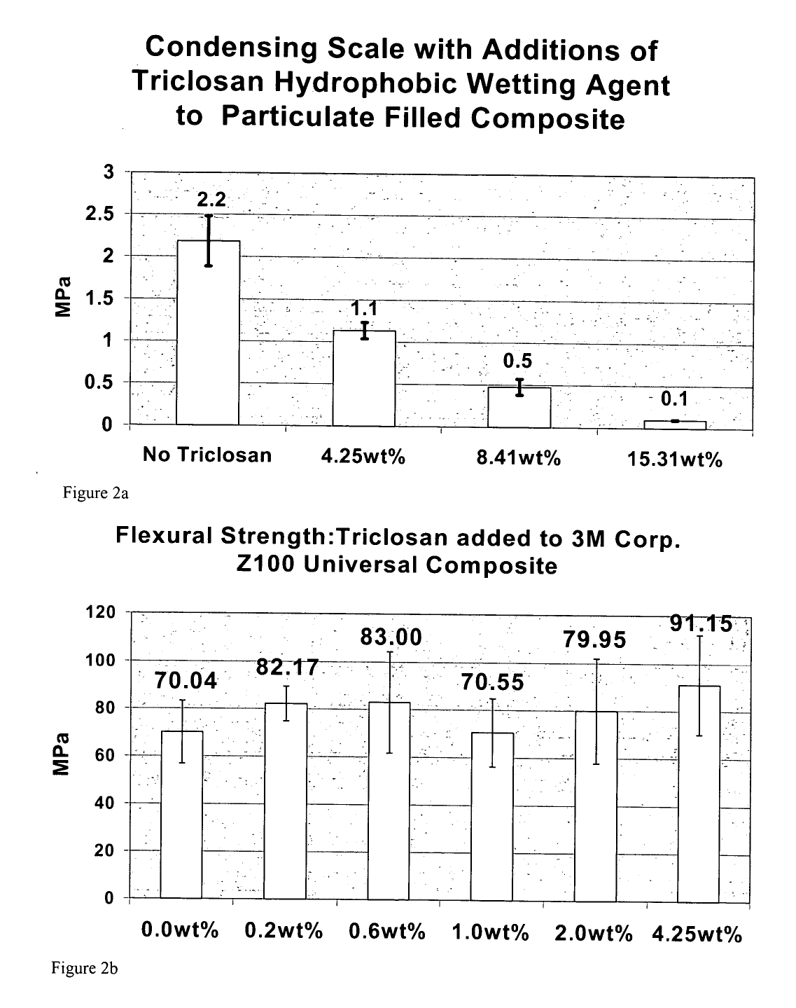

Diphenyl Triclosan electrochemical functionality disrupts secondary bonding combined with intermolecular matching between bisphenyl epoxy derived vinyl esters and related oligomers or monomers to significantly reduce viscosities of neat resins and composites. As a nonpolar molecule, Triclosan can be considered a novel hydrophobic wetting agent. To best demonstrate the ability of Triclosan to lower viscosity, a highly filled composite derived from 3M Corp. silane treated zirconium silicate particulate 84 wt % with a vinyl ester:crosslinking diluent monomer ratio of 2:1 was formulated to accentuate thickened consistency. Viscosity reductions were measured as a Condensing Scale in MPA describing maximum force/unit packing area. As Triclosan concentrations increased, viscosities reduced and correlation for reduction in the Condensing Scale values with Triclosan addition was significant p<0.000000 with r=0.9238, FIG. 2a.

A similar particulate filled composite using commercial 3M Corp. Z100, 84.5 wt % silane treated zirconium silicate and vinyl ester:crosslinking diluent ratio 50:50, was used to test flexural strengths with addition of Triclosan. Testing was stopped at 4.25 wt % as consistency was so entirely reduced that tack became completely unmanageable. The heightened viscosity reduction experienced over the previous testing on the Condensing Scale is due to the higher levels of diluent monomer in the Z100 commercial composite. Nevertheless, strengths showed a general increasing trend with Triclosan addition in spite of cumulative mixing porosity that occurred as the hydrophobic wetting additive was sequentially incorporated, FIG. 2b. Strength improvements are often used as a sign that compatibilization is occurring between different domains with better blending, reduced agglomeration and polymer entanglement. It will be further demonstrated that reinforcing fibers thoroughly improve flexural strength so completely above particulate filled composite that addition of Triclosan can not possibly adversely affect advanced material performance.

Unlike fiber reinforcement that dominates all properties with increases in modulus, strength and toughness, particulate filler generally produces modulus increases but can conversely produce losses in strength by forming stress concentrators especially when van der Waals forces of attraction form significant agglomerations with nanoparticulate. Also polarization of any particulate for example without silane treatment will tend to segregate away from nonpolar triclosan to create some stress concentration. Therefore application testing would be recommended where chipping might be a consideration in areas under stress and where material forms thin sections. However as a general rule, a hydrophobic wetting agent such as diphenyl ether Triclosan can improve quality especially in bisphenyl-A vinyl esters by allowing higher levels of filler additives through a reduction in interfacial porosity. Incorporation of important additives are often limited due to the viscosity increases they impose for example when using various fillers for flame retardant, thermal conductivity/insulation, electrical conductivity/insulation, radio-opacity, UV protection, anti oxidents, tougheners, tackifiers, adhesion promoters, pigments and antimicrobials. As a result of hydrophobic wetting, reductions in viscosity will allow greater amounts of higher molecular weight resin or less monomer to be placed and even provide more fiber reinforcement to be added. A reduction in monomer levels will result in lower material polarity to reduce moisture adsorption and increase mechanical properties. If viscosity reduction becomes excessive by addition of Triclosan, fibers can be added to effectively counteract loss of consistency with attendant increases in strength, modulus, toughness and most other mechanical properties. Also hydrophobic wetting agents are generally thought to act in synergy with silanes such that nonpolar similarities produce compatibilization with entanglement.

### Compatibilizer Additive

Compatibilization previously noted during testing for Hydrophobic Wetting is further presented by adding Triclosan to neat vinyl ester resin, fiber reinforced molding compound and an advanced medical orthopedic bone cement model.

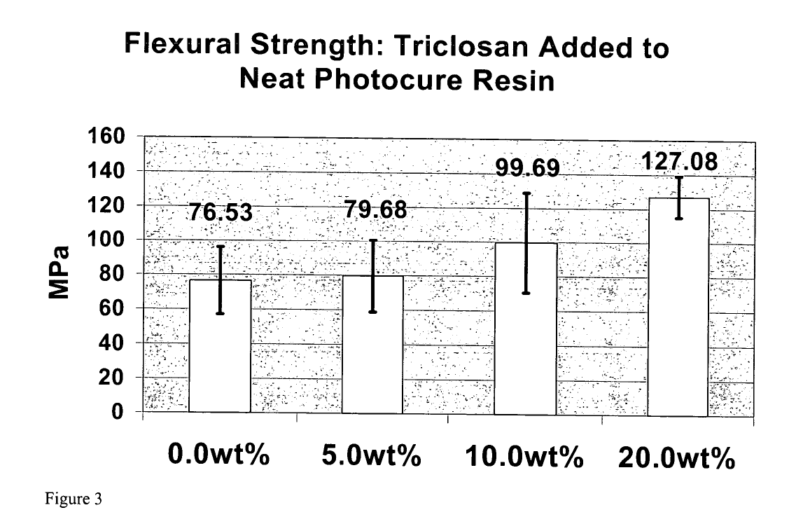

When Triclosan is incorporated into a neat vinyl ester resin system, 2:1 vinyl ester:monomer, strengths continue to increase during testing up to 20-wt %, FIG. 3. Increased strengths during incorporation of an additive can be used as an indication that compatibilization has occurred especially with Triclosan's unique electrochemical functionality. Compatibilization strength noted here is often described as evidence that polymer resin chain entanglements have taken place with toughness improvements. Large strain increases were also noted for lower modulus but specifically indicates resin toughening as strengths extended. Lower modulus resins with Triclosan further emphasizes the need for fiber reinforced strengths to prevent strain-related microcracking that can lead to crack propagation and chipping with microdefects that could breed bacteria in susceptible environments.

Further proof of compatilization is presented with addition of 90 wt % Triclosan into vinyl ester resin. At 75 wt % vinyl ester resin to 25 wt % crosslinking monomer, free radical photocuring produced an adhesive cement paste with average compressive strengths of 25 Mpa. However, adhesiveness and strength for 90 wt % Triclosan decreased to become nonexistent as the concentration of nonphenyl monomer diluent was added up to 50 wt % when combined with normal levels of curing agent. Addition of more polar aliphatic acrylates and urethanes produced the same strength weakening effect when replacing bisphenyl vinyl ester resin in addition to lower more normal curing agent concentrations. Therefore, extra curing agents are highly recommended to overcome the tendency of Triclosan's dipole to become exposed in the presence of more polar resin or monomer functional groups. Triclosan and vinyl ester resin compatibilization at such high concentrations of 90 wt % Triclosan in combination with extra curing agents would become practically therapeutic as a sedative base or a temporary material placed for easy removal.

Compatibilization strengths were seen with particulate silicate filler, FIG. 2b, previously demonstrating hydrophobic wetting and will be established for fiber reinforced composite and acrylic bone cement. Lower neat resin viscosity translates into less monomer required, and less cure shrinkage with related internal residual cure stresses that can concentrate along bonded surfaces. Lower viscosity allowing higher filler will further increase modulus and also decrease cure shrinkage

### Fiber Reinforced Molding Compound

Fibers have been considered for dental composites from the time when German investigators proposed glass wool with the initial chemical-cure tertiary amines before World War II. Bowen contemplated fibers when developing the vinyl ester resin based composites in the early 1960's but instead chose particulate filler. Fibers with lengths extending up to approximately 400 microns were studied later through articles in the Journal of the American Dental Association. However, the sparse number of longer fibers providing improved strengths was not sufficient to offset surface roughness causes by dislodging of smaller fiber. Consequently, dental fiber reinforced composites were discontinued. Later, fibers were introduced with longest fibers extending to 300 microns and more recently 70-micron length fibers are used in a commercial dental composite. Still, a critical fiber length with adequate interfacial shear bond strength with the resin must be met to prevent debonding surface roughness problems and also in satisfactory numbers to actualized mechanical properties. As a solution, U.S. Pat. No. 6,270,348 successfully addresses these earlier concerns utilizing resin preimpregnated nine-micron diameter pure quartz fibers with lengths extending from 1-mm to at least 3-mm.

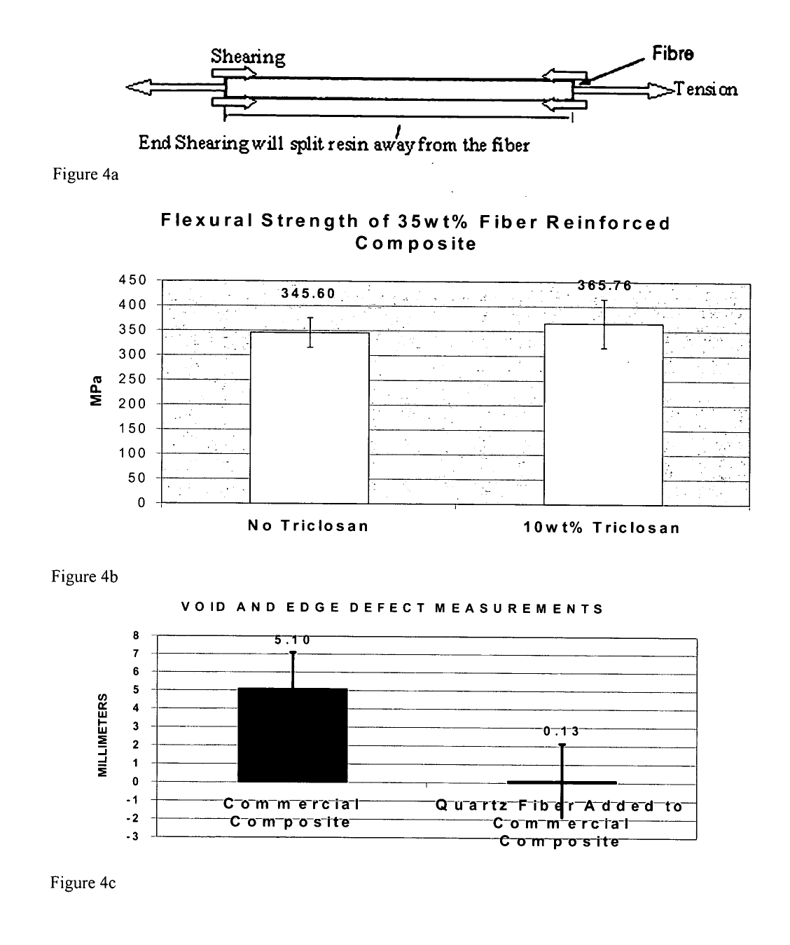

When fiber reinforced composite goes into tension, FIG. 4a, the lower modulus resin will strain first and start to debond at the fiber ends. The higher modulus fiber goes into tension at a much lower strain rate, creating shear against the resin and debonding occurs at a rate dependent on the interfacial shear bond strength between the fiber and resin. Debonding will proceed from the fiber ends continuing toward the midline until a sufficient amount of interfacial shear strength remains that equals the strength of the fiber which will then break. However, to obtain the high strengths of the fiber, a critical length must be achieved so that the entire reinforcement does not debond from the resin matrix before stress transfer can occur through the composite. Therefore a critical length (Lc) must be achieved related through a force balance between the effective interfacial shear bond force (Fₛ) and the force on the fiber (Ff) according to the following equations such that:
Fₛ equals the shear bond strength (τ) times the surface area (2πrh) between the fiber and resin excluding the ends or
   Fₛ=τ2πrh where h=½ L_{c} (L_{c} is the combined lengths from both ends) and F_{f} equals the fiber strength (σf) times the cross sectional area (πr²) or
   F_{f}=σ_{f}πr² such that
   τπrL_{c}=σ_{f}πr² and
   L_{c}=π_{f}r/τ or L_{c}=π_{f}d/2τ
Where again, Fₛ is the shear force between the fiber and resin matrix, F_{f} is the force on the fiber in tension, τ is the shear stress between the fiber and resin, σ_{f} is the fiber strength in tension, r is the fiber radius or d the fiber diameter, and h is the distance of the force from one fiber end or ½ L_{c}.

As a result, a minimum fiber length is required to achieve the strength of the fiber for stress transfer and is dependent on the interfacial shear bond strength with the resin and the fiber diameter. Once critical length is obtained most other mechanical strengths and physical properties will be improved. Composite strengths for example will increase according to the Rule of Mixtures relative to the aligned but discontinuous fibers related to a ratio of the critical length to the fiber length such that:
σ_{c}=σ_{f} Vf (1−Lc/2L)+σₘ (1−Vf) where σ_{c} equals the composite strength, σ_{f} equals the fiber strength, L is the fiber length, Lc is the critical length necessary for the fiber to break before total debonding can occur, σₘ is the matrix strength, and Vf is the volume fraction of fibers such that: Lc/2L=the proportion of fiber at the ends that can debond plastically and not contribute to strength as the fiber goes into tension.

Variation then exists conforming to fiber orientations, dispersion, stress concentrations, overlap and poor bonding at the fiber ends. A constraint continues for the volume fraction of fibers to account for lack of wetting at larger fractions that creates porosity and accentuated stress concentrators along the fiber axes. Also statistical probability of crack propagation extending around the fiber ends increases as the fiber lengths decrease or sample gauge length increases. Compared to discontinuous reinforcement, continuous strengths are defined where the fiber lengths are greater than 15-20 Lc although 95% efficiency is attained at fiber lengths of 10Lc.

The National Institute of Standards and Technology has determined that τ is about 34 Mpa for a standard photocure vinyl ester dental resin with e-glass at 16 microns diameter having a common pristine σ value of approximately 3.4 Gpa. L_{c} then calculates to be 800 microns whereby Lc/d (length/diameter), or the critical aspect ratio, would be roughly 50 for a vinyl ester resin system.

Reinforced molding compound in a vinyl ester resin system also provided increased strengths with the addition of Triclosan at 10 wt %, even with a reduction in fiber concentration, FIG. 3b. Fiber reinforcement satisfying critical lengths and percent continuous strengths will dominate most properties, but by strengthening the resin through compatibilization, durability is expected to increase. Better wetting will allow more specialty filler or reinforcement. Lower viscosity also allows higher fiber content with better wetting for increased strengths, modulus, toughness, wear and many other important material properties. By comparison, FIG. 2b, state-of-the-art commercial particulate filled dental composite by 3M Corp. produces flexural strengths well below fiber reinforced photocure composite, so that Triclosan incorporation is thoroughly protected by increased mechanical properties.

Extensive research has embraced toughening brittle matrices for fiber reinforcement. But, tougheners often suffer from moisture adsorption that will not be a problem with a nonpolar molecule such as Triclosan. Use of fiber reinforcement with attendant mechanical strength increases throughout will ensure that performance will not be compromised at any level when Triclosan is added. A Triclosan compatibilizer will toughen the resin for better interlaminar shear strength while hydrophobic wetting will reduce viscosity for improved resin impregnation to refine strength such that even more fiber reinforcement can then be increased. Improved resin wetting becomes much more important when adding fibers rather than particulate due to the large attendant viscosity increases. In addition, incorporation of modifier filler additives will be less likely to create random stress concentrators during interlaminar shearing as a result of enhanced wetting properties.

As a related property toward minimizing bacterial colonization due to porosity or voids from excessive unmanageable tack, commercial dental composites with nonresin impregnated fiber reinforcement at levels ranging from 3-6 wt % were compared to the commercial particulate filled control. Clinically associated samples borrowed from polymerization shrinkage experiments were radiographed, digitized and enlarged so that void and edge defects could be measured. When comparing the maximum lengths of area defects, fibers significantly reduce macroscopic voids, p<0.00001, FIG. 4c, evidently through a consolidation process that further limits uncontrollable tack of the matrix resin. The resultant viscosity in a molding compound becomes paramount when adding major concentration levels of Triclosan where tack becomes unmanageable and the need for fibers becomes an essential requirement.

### Glass Ionomer and Reinforcing Fibers

Fluoride release has shown reductions in secondary caries compared to composite and even amalgams. Combined addition of Triclosan may prove to be an important tool for treating caries prone patients. Current glass ionomers however are deficient in mechanical strength particularly in stress bearing areas and fluoride activity declines rapidly in time. Fiber reinforcement is contemplated for increasing mechanical strengths while Triclosan is considered for long-term retention to provide antimicrobial protection for the lifetime of the restorative filling. The following tests with charts will demonstrate the advantages of fiber reinforcement especially following resin preimpregnation in addition to Triclosan compatibility with a dual cure system:

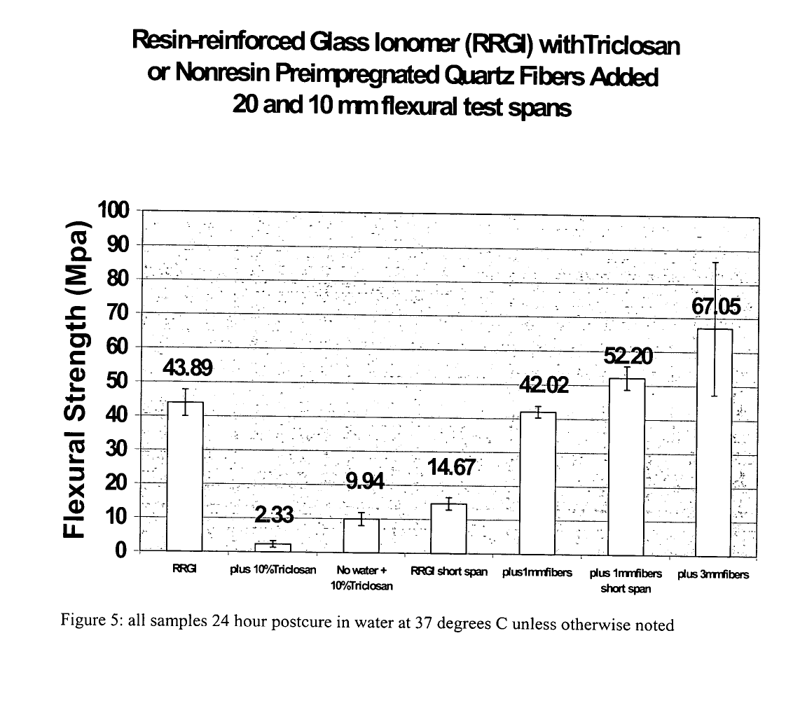

3.0 mm and 1.0 mm non resin impregnated quartz fibers were added to resin reinforced glass ionomer (RRGI) liquid and mixed with powder, placed in molds, allowed to cure, postcured for 24 hours at 37 degrees C. in a water bath and tested in three point flexural bend at 20.0 mm span, FIG. 5. RRGI was tested with 10% Triclosan, showing a great loss of strength which diminished to an extent when 24 hour water postcure was eliminated. With a span of 20.0 mm, nonresin impregnated 1.0 mm fibers at nine microns diameter do not sufficiently attain percent of continuous strength with apparent low interfacial shear bond strength to increase flexural strength over the resin modified glass ionomer control. RRGI with 1.0-mm fibers were also tested at short spans of 10.0 mm to evaluate the potential shear stresses that relate to toughness. At a span of 10.0 mm shearing effects are increased which drastically reduces brittle RRGI strength, but on the other hand lowers the statistical chance of cracks propagating between fiber thus increasing flexural strength to actually overcome shearing and boost nonresin impregnated fiber reinforced RRGI. 3.0 mm nonresin impregnated fiber reinforced RRGI at a higher percent continuous strength plus less shearing at 20 mm span increases strengths to a reasonable level that can compare to particulate filled composite, FIG. 2b.

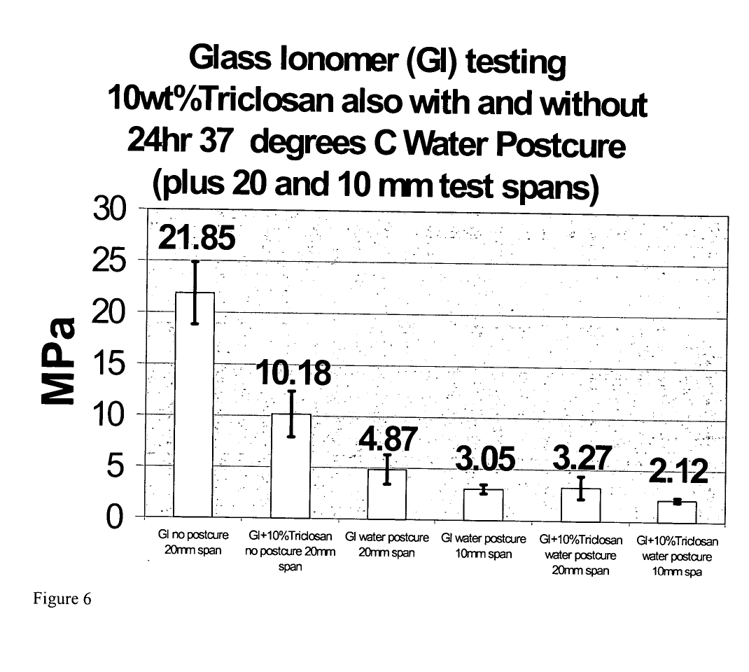

Triclosan was added to neat glass ionomer to determine effects of water adsorption where nonpolar Triclosan segregates away from polar cement, FIG. 6. Triclosan separates into stress concentrators when placed in more polar glass ionomer, thus reducing strengths. Loss of strength when adding Triclosan is noted immediately after cure. Following 24-hour water immersion at 37 centigrade, strength losses are accentuated further. During the water immersion testing, when checking shorter flexural test 10-mm spans to emphasize shearing associated with compressive failure or crushing, Triclosan segregation appeared to reduce strength almost identically to when comparing pure tensile flexural strength 20-mm spans. Through reverse engineered compatibilization, it is conceived that Triclosan could be added to glass ionomer for biodegradable material. If material placement becomes difficult due to excessive strength loss immediately after curing, Triclosan concentrations can be reduced since 10 wt % is being considered generally for hardened thermoset biostructural materials that release antimicrobial poorly. Altogether, Triclosan nonpolar chemistry dissociates excessively away from polar species such as glass ionomer to create stress concentrators with heavy reductions in mechanical strength. Compatibilization is thus not occurring with such polar/nonpolar dissimilarity. Also, water adsorption is accelerated with disassociated domains between Triclosan and glass ionomer.

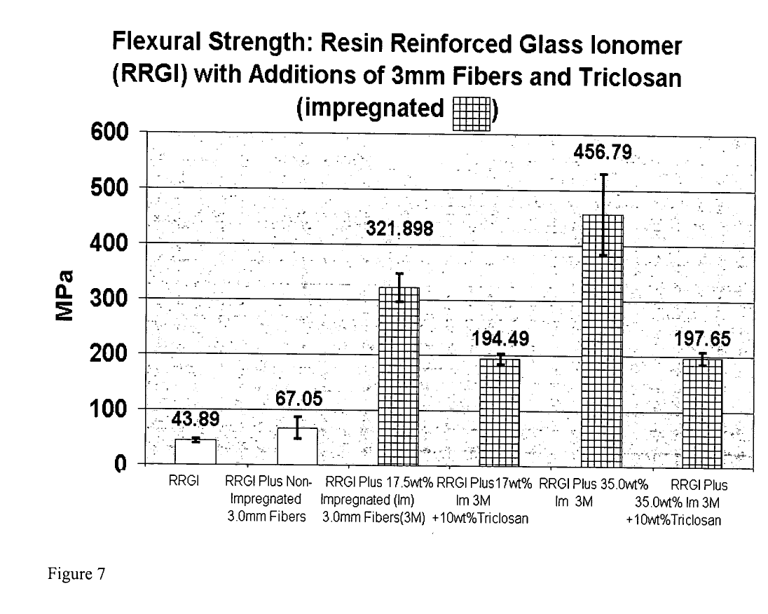

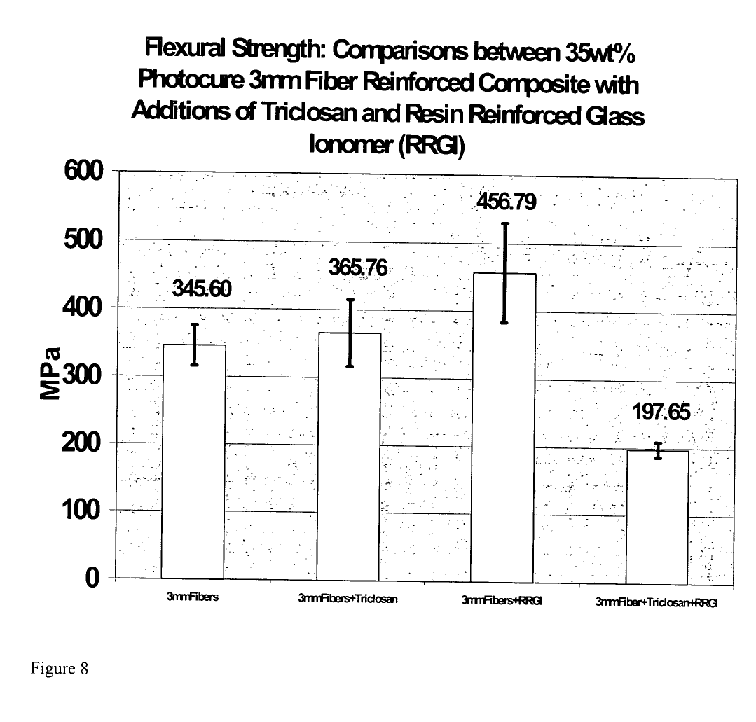

Addition of 3 mm preimpregnated photocure quartz fiber to RRGI dramatically increases strength sequentially at 17.5 wt % and 35 wt %, FIG. 7. Triclosan added to resin preimpregnated fiber reinforced dual cure RRGI regularly brings strengths back down, but test samples are still significantly exceedingly higher than the neat RRGI or conventional glass ionomer, FIG. 6.

For an overall view chart 8 is presented. Triclosan 10 wt % increases strengths of 35 wt % photocure fiber reinforced composite. Addition of RRGI to fiber reinforced composite significantly increases strength (possibly by acrylic acid condensation with silica hydroxyl groups), but is again reduced with 10 wt % Triclosan, though still greatly higher than the RRGI controls, FIG. 5 or glass ionomer, FIG. 6.

While nonpolar Triclosan is not compatible with polar glass ionomer, through reverse engineering it is expected that biodegradable materials may be developed. In addition, combined antimicrobial properties from Triclosan and Fluoride release may be obtained. When considering how fibers dominate all properties, lower glass ionomer/Triclosan compatibility can then become insignificant during reinforcement when comparing the much weaker neat commercial glass ionomer or RRGI materials.

### Addition of Triclosan to Acrylic Model for Bone Cement

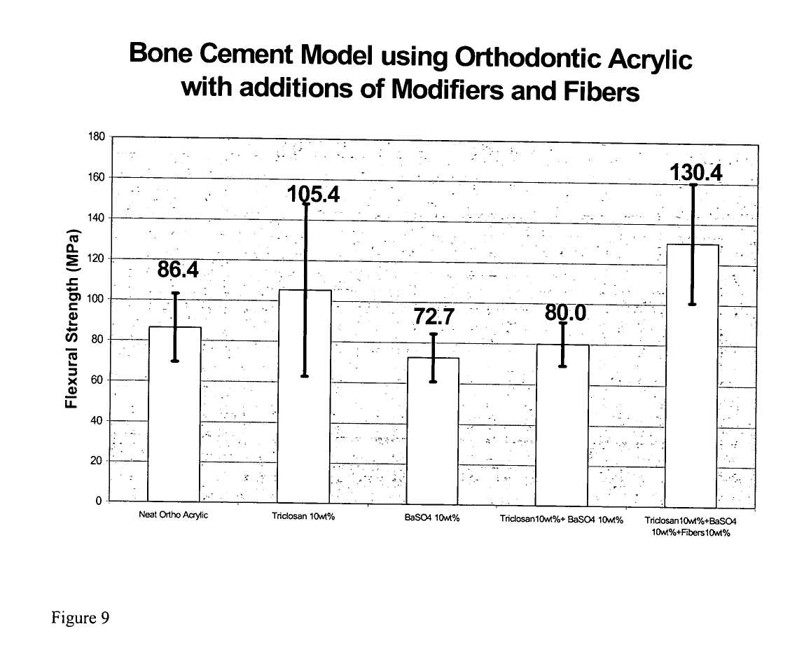

Due to the chemical similarities for the ether C—O—C Triclosan, primarily at the ester linkages (C—O bond) with methacrylate functionality, between dimethacrylate vinyl esters and polymethylmethacrylate with its various copolymers, Orthopedic Bone Cement is considered. A model is developed using Orthodontic Acrylic and then medical grade Barium Sulfate radio-opacity filler. Addition of 10 wt % Triclosan increases the strength for chemical cure polymethylmethacrylate with and without Barium Sulfate. Lower viscosity due to hydrophobic wetting by Triclosan requires fibers to control the tacky paste during handling which subsequently dramatically increases strength over the Triclosan/Barium sulfate acrylic model almost double, FIG. 9. Certain standard deviations increase when adding Triclosan presumably due to excessive tackiness that may incur void stress concentrators and after rapid incorporation of resin preimpregnated fibers that do not disperse homogeneously.

Addition of Triclosan to bone cement is expected to reduce implant related infections while improving the initial “race for the interface” regarding biofixation stabilization. During both one-stage (77-90% success rate) and two-stage revisions (>80% success rate), strength reducing antibiotics are recommended to be placed in the bone cement at only 2-3 wt %. However by adding strength promoting Triclosan, a greater measure of protection can then be provided over a longer extended time along the implant foreign body surface that becomes an area compromised to systemic antibiotics during bacterial colonization with glycolax formation. By improving compatibilized acrylic strengths and entanglement toughness along with reduced viscosity for better wetting, antibiotics should even be more safely added when reducing concern for producing stress concentrators. Moreover, resin preimpregnated fiber reinforcement can provide dramatic improvements in mechanical properties at low levels of 10 wt %. Further it should be noted that orthopedic cements are used for vertebroplasty and cranioplasty where antimicrobial protection is of greater necessity.

### Computer Simulation of Triclosan Demonstrating Energy States During Bond Rotation about the Ether Oxygen Atom: Dipole Moment and Polarity

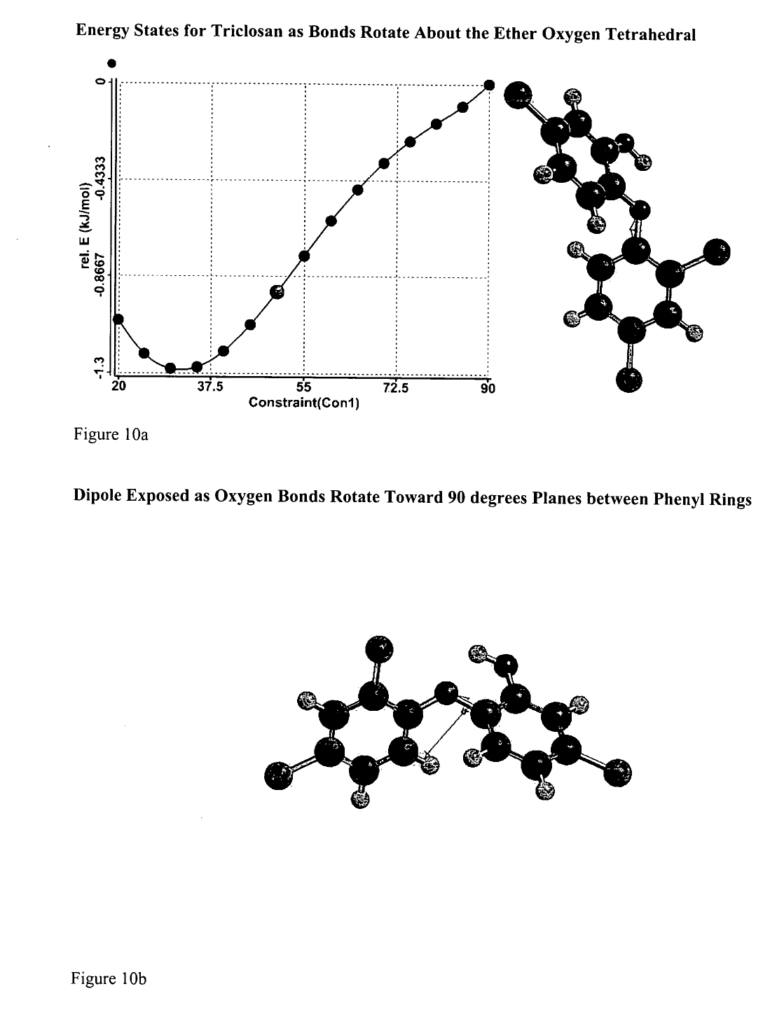

Triclosan has been previously shown to stabilize in a skewed state with intramolecular hydrogen bonding between the hydroxyl group and ether oxygen. Computer simulation has demonstrated that the tetrahedral bond angle for the oxygen ether atom with both phenyl planes is approximately 30 degrees for the lowest energy state, FIG. 10. As the bond rotates toward 90 degrees, the energy state increases, but will also expose a dipole, FIG. 11, that will entropic stabilize with more polar outer environments such as water so that minimal solubility is available.

### Other Embodiements

While the preferred embodiment of the present invention includes Triclosan use for compatibilization and hydrophobic wetting with vinyl esters and related polymer or monomers to improve neat resin, fiber reinforced compound and even orthopedic bone cement; it is also contemplated that adhesives and cements will be considered with various other additives and modifiers. Compatibilization with organo-silanes will further provide utilization as a nonpolar molecular-electrochemical-coupling modifier to entangle with polymer resin matrices for interfacial hydrophobic toughening.

Similarly the present invention encompasses fiber addition into an adhesive where bondline pressure and thickness can be controlled to also reduce porosity. Average thickness for a fiber reinforced compound after bonding pressure is on the order of approximately 200-300 microns, which can then be used to concentrate Triclosan at the immediate interface within the resin toward protecting susceptible margins from microbial attack. Fibers will squeeze filler and resin outward away from the resin mass to form an interfacial surface layer penetrating into the substrate ranging from approximately 0.1 microns to over 6 microns thick thereby concentrating any additive such as Triclosan about double over the reinforced composite.

Practically more, high-density semiconductor micro circuitry requires increased final downstream microcontamination defense. Microelectronics would be better protected at this critical end use from self-replicating microbial contaminants, including bacteria, fungus and even virus using resistive nonpolar Triclosan antimicrobial for polymer-based photoresists, coatings, encapsulants and circuit boards. Nonpolar Triclosan should further enhance electronic quality by reducing viscosity and polar monomer levels, to thereby lower environmental moisture ingress and increase important additive levels required for thermal conductivity.

In addition beyond material properties, therapeutic levels of Triclosan can be delivered in vinyl ester photocure cements at concentrations up to 90 wt %. Triclosan impregnated biodegradable implants may reduce the level of microbes as an antimicrobial, improve healing as an anti-inflammatory and treat pain as an analgesic.

Although the present invention has been described with reference to specific embodiments, those of skill in the art will recognize that changes may be made thereto without departing from the spirit and scope of the invention as set forth in the hereafter-appealed claims.

1. Triclosan as a nonpolar electrochemical functional molecule is a modifier for compatibilization toward resin/monomer entanglement toughness especially in thermoset bisphenyl-A vinyl ester resin based materials and related polymers, resins or monomers and also provides hydrophobic wetting for improving resin mobility during filler/reinforcement impregnation

2. Advantageous properties described by claim 1. are modified according to a dipole that can become exposed in the presence of more polar functional group environments such that additional curing agents may be required to ensure free radical polymerization.

3. The advantageous properties described by claim 1. practically apply to a material that comprises: a thermoset resin; a plurality of silica-based fibers at least 1-3 mm in length mixed into a resin; wherein Triclosan has a concentration greater than 1.0 wt % of the total material mass composition.

4. The advantageous properties described by claim 1. practically apply to a material that comprises: a thermoset resin; a plurality of silica-based fibers at least 1-3 mm in length mixed into a resin; wherein Triclosan has a concentration greater than 2.0 wt % of the total material mass composition.

5. The advantageous properties described by claim 1. practically apply to a material that comprises: a thermoset resin; a plurality of silica-based fibers at least 1-3 mm in length mixed into a resin; wherein Triclosan has a concentration greater than 5.0 wt % of the total material mass composition.

6. The advantageous properties described by claim 1. practically apply to a material that comprises: a thermoset resin; a plurality of silica-based fibers at least 1-3 mm in length mixed into a resin; wherein Triclosan has a concentration greater than 10.0 wt % of the total material mass composition.

7. The advantageous properties described by claim 1. practically apply to a material that comprises: a thermoset resin; a plurality of silica-based fibers at least 1-3 mm in length mixed into a resin; wherein Triclosan has a concentration greater than 20.0 wt % of the total material mass composition.

8. The advantageous properties described by claim 1. practically apply to promote biodegradation through reverse engineering for a material that comprises: a polar thermoset resin; wherein Triclosan has been compounded and may also include a plurality of silica-based fibers at least 1-3 mm in length for reinforcement.

9. The advantageous properties described by claim 1. practically apply to a material that comprises a neat unfilled or unreinforced vinyl ester based thermoset cure resin system; wherein Triclosan has a concentration greater than 1.0 wt % of the neat resin.

10. The advantageous properties described by claim 1. practically apply to a material that comprises a neat unfilled or unreinforced vinyl ester based thermoset cure resin system; wherein Triclosan has a concentration greater than 5.0 wt % of the neat resin.

11. The advantageous properties described by claim 1. practically apply to a material that comprises a neat unfilled or unreinforced vinyl ester based thermoset cure resin system; wherein Triclosan has a concentration greater than 10.0 wt % of the neat resin.

12. The advantageous properties described by claim 1. practically apply to a material that comprises a neat unfilled or unreinforced vinyl ester based thermoset cure resin system; wherein Triclosan has a concentration greater than 20.0 wt % of the neat resin.

13. The advantageous properties described by claim 1. practically apply to a material that comprises a neat unfilled or unreinforced vinyl ester based thermoset cure resin system; wherein Triclosan has a concentration greater than 90.0 wt % of the neat resin.

14. The advantageous properties described by claim 1. practically apply to a material that comprises an acrylic-based polymer or copolymer thereof for orthopedic bone cement and has a Triclosan concentration of at least 1.0 wt % of the total resin mass.

15. The advantageous properties described by claim 1. practically apply to a material that comprises an acrylic-based polymer or copolymer thereof for orthopedic bone cement and has a Triclosan concentration of at least 5.0 wt % of the total resin mass.

16. The advantageous properties described by claim 1. practically apply to a material that comprises an acrylic-based polymer or copolymer thereof for orthopedic bone cement and has a Triclosan concentration of at least 10.0 wt % of the total resin mass.

17. The advantageous properties described by claim 1. practically apply to a material that comprises an acrylic-based polymer or copolymer thereof for orthopedic bone cement and has a Triclosan concentration of at least 20.0 wt % of the total resin mass.

18. An additive as described by claim 1. practically applies to a material that comprises an acrylic-based polymer or copolymer thereof for orthopedic bone cement which includes supporting silica-based fibers at least 1-3 mm long to control viscosity loss from excessive Triclosan hydrophobic wetting such that reinforcement provides thickening along with improving mechanical properties.

19. The advantageous properties described by claim 1. practically apply to promote vinyl ester thermoset adhesives or cements: wherein Triclosan has been compounded and also includes a nominal amount of silica-based fibers for reinforcement.

20. A material additive as described by claim 1. practically applies to resin based thermoset polymers for coating circuit boards or microelectronics, encapsulating electronic components and incorporating within photoresists.
